(19) United States
(12) Patent Application Publication
(10) Pub. No.: US 2015/0370546 A1
(43) Pub. Date: Dec. 24, 2015

(54) METHOD AND APPARATUS FOR GENERATING DATA DISTRIBUTION SERVICE APPLICATION

(71) Applicant: Electronics and Telecommunications Research Institute, Daejeon (KR)

(72) Inventors: Kyung Il KIM, Daejeon (KR); Kyeong Tae KIM, Daejeon (KR); Yong Yeon KIM, Daejeon (KR); Je Man PARK, Gwangju (KR); Soo Hyung LEE, Daejeon (KR); Hyung Kook JUN, Daejeon (KR); Won Tae KIM, Asan (KR)

(21) Appl. No.: 14/615,918

(22) Filed: Feb. 6, 2015

(30) Foreign Application Priority Data
Jun. 24, 2014 (KR) 10-2014-0077389

(51) Int. Cl. G06F 9/45; G06F 17/27

(52) U.S. Cl. CPC G06F 8/436; G06F 17/271

(57) ABSTRACT

Provided herein a method and apparatus for generating a data distribution service application, the method including syntax-analyzing an IDL (interface description language) file; determining a topic model to be used in the data distribution service application based on a result of the syntax-analyzing of an IDL (interface description language) file; receiving QoS information and determining a QoS model by a QoS (quality of service) modeler; determining a DDS application model based on the topic model and QoS model by a DDS (data distribution service) application modeler; and generating a source code based on the topic model, QoS model and DDS application model.

### CROSS-REFERENCE TO RELATED APPLICATION

The present application claims priority to Korean patent application number 10-2014-0077389, filed on Jun. 24, 2014, the entire disclosure of which is incorporated herein in its entirety by reference.

### BACKGROUND

1. Field of Invention

Various embodiments of the present invention relate to the data distribution service, and more particularly, to a method and apparatus for generating a data distribution service application.

2. Description of Related Art

DDS (Data Distribution Service) is a communication middleware having publish-subscribe specifications for a distributed environment. In order to provide the data distribution service, a data-centric publish-subscribe programming model needs to be standardized for a distributed environment.

Although conventional distributed object middleware standards such as CORBA (Common Object Request Broker Architecture) and DCOM (Distributed Component Object Model) have numerous advantages in sharing resources and object reusability, they are remote procedure call based. Therefore, they may not be suitable in an environment where massive data needs to be distributed and exchanged quickly, due to problems of transmission delay and inefficiency in bandwidth. For example, in new types of distributed multimedia applications such as VOD, video conference, and VoIP (Voice over Internet Protocol), data needs to be transmitted in real time, and massive data needs to be processed continuously, but many problems may occur such as network delay due to different platform environments and too much information transmission.

An advantage of the data distribution service is that numerous users can form a dynamic network regardless of the physical network configuration, and that users can reliably transmit in real time the information they are interested in as publishers and subscribers. Due to these characteristics, OMG (Object Management Group) recommends using the data distribution service in services such as C4I, industrial automation, distributed control and simulation, communication apparatus control, sensor networks, and network management systems that require high reliability and real time transmission.

### SUMMARY

A first purpose of various embodiments of the present invention is to provide a method for generating a data distribution service application.

A second purpose of various embodiments of the present invention is to provide an apparatus for performing the method for generating a data distribution service application.

According to an embodiment of the present invention, there is provided a method for generating a data distribution service application, the method including syntax-analyzing an IDL (interface description language) file; determining a topic model to be used in the data distribution service application based on a result of the syntax-analyzing of an IDL (interface description language) file; receiving QoS information and determining a QoS model by a QoS (quality of service) modeler; determining a DDS application model based on the topic model and QoS model by a DDS (data distribution service) application modeler; and generating a source code based on the topic model, QoS model and DDS application model. The topic model may be a model for a topic for generating the data distribution service application, and the topic may indicate information on a format and material type of data transmitted and received in a data distribution service. The QoS model may be a model for QoS for generating the data distribution service application, and the QoS may indicate an attribute of service quality that the topic or a DataWriter or DataReader of the data distribution service has. The DDS application model may be modeled based on an attribute of the DataWriter or DataReader to be generated in the data distribution service application, the topic, and the QoS. The source code may embody a function for communicating with another data distribution service application based on a communication function that the data distribution service application provides in a data distribution service communication middleware.

According to another embodiment of the present invention, there is provided an apparatus for generating a data distribution service application, the apparatus including an IDL parser configured to syntax-analyze an IDL (interface description language) file; a topic modeler configured to determine a topic model to be used in the data distribution service application based on a result of the syntax-analyzing of an IDL file; a QoS modeler configured to receive QoS information and to determine a QoS model; a DDS application modeler configured to determine a DDS application model based on the topic model and QoS model; and a source code generator configured to generate a source code based on the topic model, QoS model, and DDS application model. The topic model may be a model for a topic for generating the data distribution service application, and the topic may indicate information on a format and material type of data transmitted and received in a data distribution service. The QoS model may be a model for QoS for generating the data distribution service application, and the QoS may indicate an attribute of service quality that the topic or a DataWriter or DataReader of the data distribution service has. The DDS application model may be modeled based on an attribute of the DataWriter or DataReader to be generated in the data distribution service application, the topic and the QoS. The source code may embody a function for communicating with another data distribution service application based on a communication function that the data distribution service application provides in a data distribution service communication middleware.

By using a method and apparatus for generating a data distribution service application according to the aforementioned embodiments of the present invention, it is possible to easily generate numerous codes that are complicated and repeated numerous times when developing an application program that uses the data distribution service. Furthermore, it is possible to minimize the time and cost for developing an application program that uses the data distribution service.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a conceptual view illustrating a structure of DDS;

FIG. 2 is a conceptual view illustrating a middleware;

FIG. 3 is a conceptual view illustrating a communication method using DDS;

FIG. 4 is a conceptual view illustrating an apparatus for developing a data distribution service application according to an embodiment of the present invention; and

FIG. 5 is a flowchart for executing an apparatus for developing a data distribution service application.

FIG. 6 is a block diagram illustrating an example of an apparatus to which an embodiment of the present invention may be applied.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

DDS (Data Distribution Service) is a reliable real time data communication middleware standard that was made by the need to standardize a data-centric program model for a distributed environment based on a publish-subscribe model. A purpose of DDS is to simplify complicated network programming to enable transmitting data regardless of the location or existence of applications that participate in the communication, thereby simplifying the design and embodiment of the distributed applications. DDS standard consists of DCPS (DDSv1.2 API Standard) that states DDS /API standard, and RTPS (RTPS v2.1 Wire Protocol Standard) that states a network layer communication protocol. DCPS (Data Centric Publisher/Subscriber) is an interface standard that provides a data exchange function based on a publish-subscribe model.

DDS forms a network data domain dynamically, and provides a data communication environment where an embedded device or mobile device can freely participate therein or withdraw therefrom, and thus DDS may be utilized as middleware suitable for the national defense field.

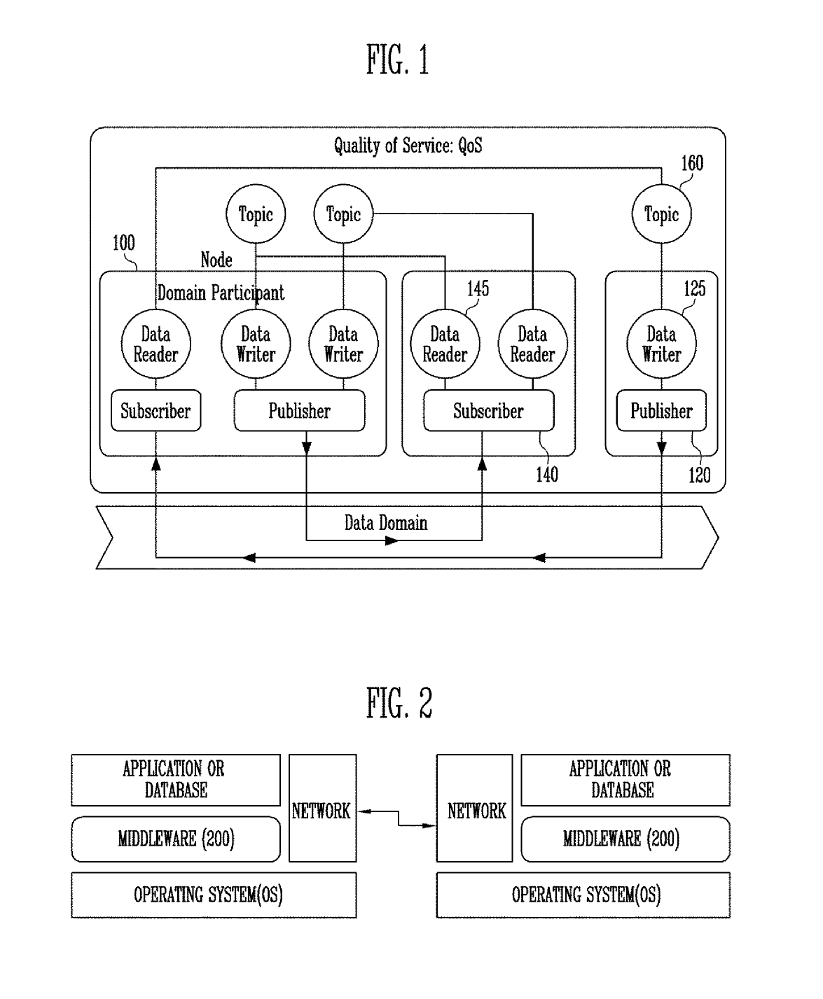

FIG. 1 is a conceptual view illustrating a structure of DDS.

Referring to FIG. 1, a domain participant 100 is an entity that represents DDS communication in an application. A publisher 120 plays the role of generating and distributing data to be transmitted. A DataWriter 125 may set a data value to publish the application under a topic.

A subscriber 140 receives data transmitted from the publisher through a data domain and utilizes the data received. When the application notifies that there is data that it is interested in, the DataReader 145 may allow it and access data received from an annexed subscriber.

Herein, the publisher 120 and subscriber 140 must be participating in a same domain in DDS, and data must be defined in the form of a topic (concept) of DDS. A topic 160 is a concept separated from TopicDescription. It is a basic description of almost all data, and it may be published or subscribed. The topic may be a virtual data transmitting/receiving channel.

DDS presents a standard for setting QoS such as “durability, history, reliability, ownership, and deadline” for a reliable and real time transmission of topic data.

RTPS (Real Time Publish/Subscribe) is a data transmission protocol for embodying a publish-subscribe model, and it is designed to be operable even on a transmission layer that lacks reliability. RTPS states matters regarding discovery, data coding method, message format and exchange method, and transmission procedure necessary for a publisher or subscriber object defined by DCPS (Data Centric Publish Subscribe) to actually communicate.

Hereinbelow, DCPS and RTPS will be explained in detail.

DCPS is an interface for a data publish-subscribe function provided in an application program. Through this layer, the application program performs only the publish-subscribe function of data of interest without any perception of a counterpart to exchange data with. DCPS which is a basic interface provides read( )/writer( ) type API to provide a data exchange function between application programs in a read/write method. It also provides a function of setting a value for transmission data and publishing the set data, and enables receiving data of an item of interest received and registered in a subscribing application and approaching to a value of the received data. Furthermore, it enables defining a topic, defining a topic type, generating a Publisher/Subscriber Entity, setting QoS for each entity, and operating all entities.

A Publisher/DataWriter exists at a transmitting side. A Publisher is in charge of distributing data, and publishes data defined in various types. The Publisher may possess a plurality of DataWriters depending on the type of topic to be published, and each DataWriter may allocate a value for the topic suitable to a particular data type.

A Subscriber/DataReader exists at a receiving side. A Subscriber receives published data and enables an application to use the data received. The application approaches the received topic using a DataReader.

RTPS(Real Time Publish/Subscribe) is a data transmission protocol for the data-centric distribution service standardized by OMG. It is configured to support a data Publish/Subscribe communication model, and is configured to be operable even on an unreliable transmission layer like UDP/IP.

RTPS consists of basic modules that may be classified into four types as below.

(1) Structure Module: A Structure Module defines an object that may participate in communication when exchanging data according to RTPS standard.

(2) Message Module: A Message Module defines a message to be used in information exchange between a Writer and Reader of RTPS.

(3) Behavior Module: A Behavior Module defines a message transmission procedure that would be performed under state and time conditions between an RTPS Writer and Reader.

(4) Discovery Module: A Discovery Module performs a function of searching for information on an object related to distributing data existing in a domain. The Discovery Module uses two types of protocols: PDP (Participant Discovery Protocol) which is a protocol for searching for a participant on a different network, and EDP (Endpoint Discovery Protocol) which is a protocol used to exchange search information between different endpoints.

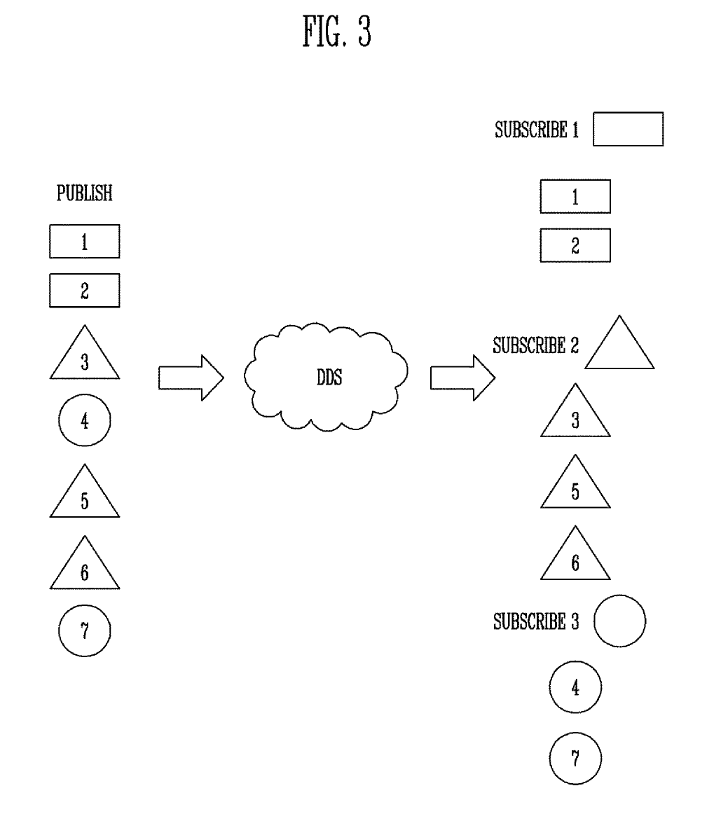

FIG. 2 is a conceptual view illustrating a middleware.

FIG. 2 illustrates the role and structure of a middleware 200. Hereinafter, a distribution service application that will be disclosed in the embodiment of the present invention may perform the role of a middleware 200.

The middleware 200 plays a role of connecting a client and a server application. A client and server is usually expressed as ‘C/S’, wherein ‘/’ may mean middleware 200. The middleware 200 provides a base structure for distributed computing, and has much effect on the development of client server technology.

Referring to FIG. 2, the middleware 200 refers to software necessary for mutual operability between different systems, and the middleware 200 may provide compatibility for a DB (database) and OS (operating system). The reason why the middleware 200 is important in the C/S technology is because not only does the logical structure (2-layer, 3-layer) of the C/S system changes depending on what kind of middleware 200 is used in constructing a system, it may also bring changes in the base structure of an entire system.

In an object-oriented system, applications exist over a wide range of area in a network in the form of distributed objects, and thus in today's distributed computing environment, it is essential to use an object middleware that provides a safe mutual communication and management service of the distributed objects. DCOM of OMG/CORBA and Microsoft, which is the current industrial standard, is the object middleware mainly used in constructing an information system. Middleware is also changing together with the development of information technology. Various models and structures are being developed from RPC (Remote Procedure Call) model which is a traditional application communication to ORB (Object Request Broker) which is an inter-object message model. It is very difficult to define the range of middleware or classify middleware. The reason is because middleware must include everything from functions of a network protocol (TCP/IP, SNA, NetBIOS) and DB driver to the role of a TP-MONITOR and distributed object.

FIG. 3 is a conceptual view illustrating a communication method using DDS.

Socket communication may be convenient in 1:1 communication. It may also be convenient in 1:N communication if the data type to be transmitted is the same and the client knows the address of the server. However, it may be difficult to use socket communication when sending an unspecified type of data to unspecified targets in packets.

A DDS middleware can resolve this problem at the middleware level. Therefore, a developer becomes able to write an application program without having to deeply think about the network program. A socket transmits and receives data in a send/recv method.

DDS may transmit and receive a topic (packet) in a publish-subscribe method.

First of all, at a publisher side, data to be transmitted may be defined based on ‘MDSTypedata_mds;,MDSTypedatakey_mds;’, and then a setting for communication may be made, and then the data may be transmitted through a write that is a function of a publish object (for example, p_foodataWriter->write(p_foodataWriter, dFoo, 0)). The data may be transmitted through the middleware without having to know who the target is.

Likewise, at a subscriber side, the type of data to be received may be defined based on ‘MDSTypedata_mds;,MDSTypedatakey_mds;’, and then a setting for communication may be made, and then the data may be subscribed based on a take (take is a function of a subscribe object) (for example, p_datareader->take(p_datareader, & fseq, & sseq, 1, ANY_SAMPLE_STATE, ANY_VIEW_DTATE, ANY_INSTANCE_STATE). After the take, it may be determined whether or not the data is necessary data, and then the data may be used.

The subscriber side receives a topic called MDSType in this case, but the subscriber side may receive other types of topic instead. When it is set to receive another type of topic, after the take is called, another type of topic may be received.

As illustrated in FIG. 3, in DDS, the publisher side has only to publish a topic without having to care about the state or data type of a client, and the subscriber side may receive what it is interested in regardless of what the publisher side publishes, thus providing convenience to the application programmer.

FIG. 4 is a conceptual view illustrating an apparatus for developing a data distribution service application according to an embodiment of the present invention.

Referring to FIG. 4, an apparatus for developing a data distribution service application according to an embodiment of the present invention 400 may include an IDL parser (interface definition language parser) 401 and topic modeler 402, topic model 403, QoS modeler 404, QoS model 405, DDS application modeler 406, DDS application model 407, and DDS application compiler 408.

The IDL parser 401 may receive an IDL file 410 written and transmitted from outside, syntax-analyze contents in the IDL file 410, and then transmit the analyzed result to the topic modeler 402.

An IDL (Interface Description Language or Interface Description Language) is a specification language used to describe a software components' interface. IDLs describe an interface in a language-independent way, enabling communication between software components that do not share a language—for example, between components written in C++ and components written in Java.

The topic modeler 402 may define or modify a topic to be used in a data distribution service application program. The defined or modified topic to be used in a data distribution service application program may be reflected in the topic model 403.

The topic may indicate a format and material type of data transmitted and received in the data distribution service. The topic model 403 may be a model for handling the topic inside an apparatus for developing a data distribution service application.

The QoS modeler 404 may define or modify QoS to be used in a data distribution service application program. A result determined in the QoS modeler 404 may be reflected in the QoS model 405. QoS may include an attribute of service quality that the topic or a DataWriter or DataReader of the data distribution service has. The QoS model 405 may be a model for handling QoS inside the apparatus for developing a data distribution service application.

The DDS application modeler 406 models a data distribution service application program itself, and its result may be reflected in the DDS application model 407. The DDS application model 407 may model the data distribution service application program to include numerous attributes of the DataWriter and DataReader, related topics and QoS to be generated inside the data distributions service application program.

The DDS application compiler 408 may receive a topic model 403, QoS model 405, and DDS application model 407 through a topic modeler 302, QoS modeler 404, and DDS application modeler 406, and generate a source code 420 for a data distribution service application program suitable to a target system. The source code 420 generated may use a communication function that the data distribution service application program provides in a data distribution service communication middleware to contain a function necessary for communicating with another data distribution service application program.

FIG. 5 is a flowchart for executing an apparatus for developing a data distribution service application.

Referring to FIG. 5, an IDL file may be syntax-analyzed (S500).

An IDL parser may syntax-analyze the IDL file received and identify contents of a topic.

A topic model is determined (S510).

A topic modeler may generate or edit a topic model upon directly receiving topic information or using the contents of the topic analyzed at step 500.

A QoS model is determined (S520).

A QoS modeler may receive QoS information from a user and generate or edit the QoS model.

A DDS application model is determined (S530).

A DDS application modeler may receive information on a data distribution service application program from a user, and generate or edit the DDS application model.

A source code is generated (S540).

The topic model, QoS model, and DDS application model may be received to generate the source code for a data distribution service application program suitable to a target system.

By using a method and apparatus for generating a data distribution service application according to the aforementioned embodiments of the present invention, it is possible to easily generate numerous codes that are complicated and repeated numerous times when developing an application program that uses the data distribution service. Furthermore, it is possible to minimize the time and cost for developing an application program that uses the data distribution service.

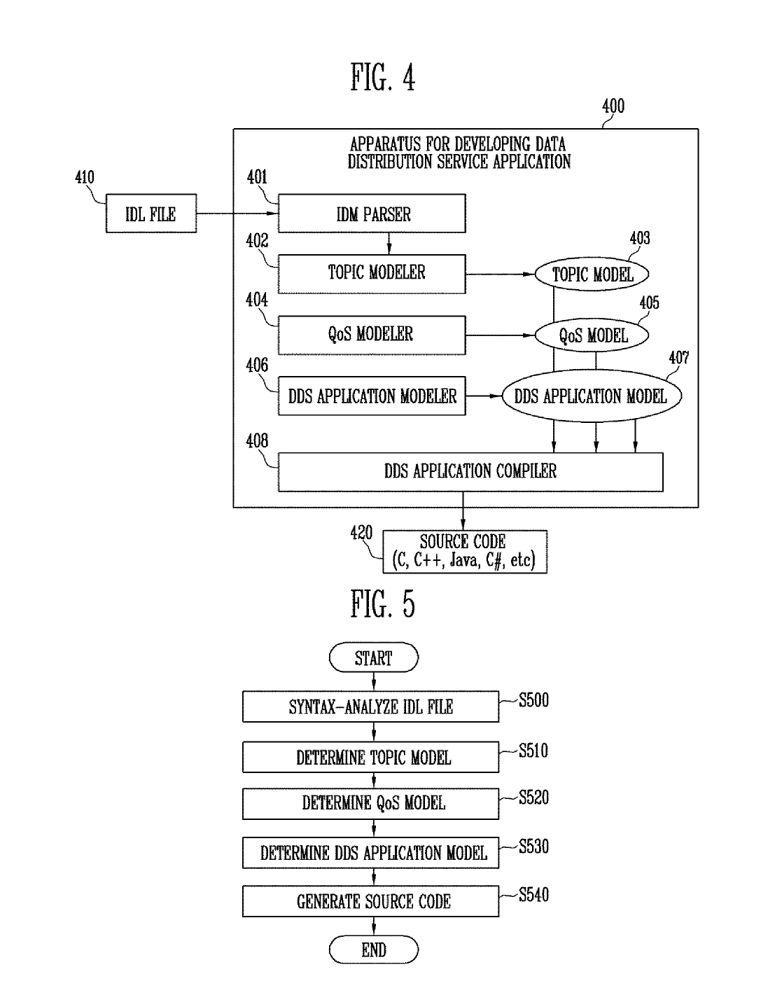

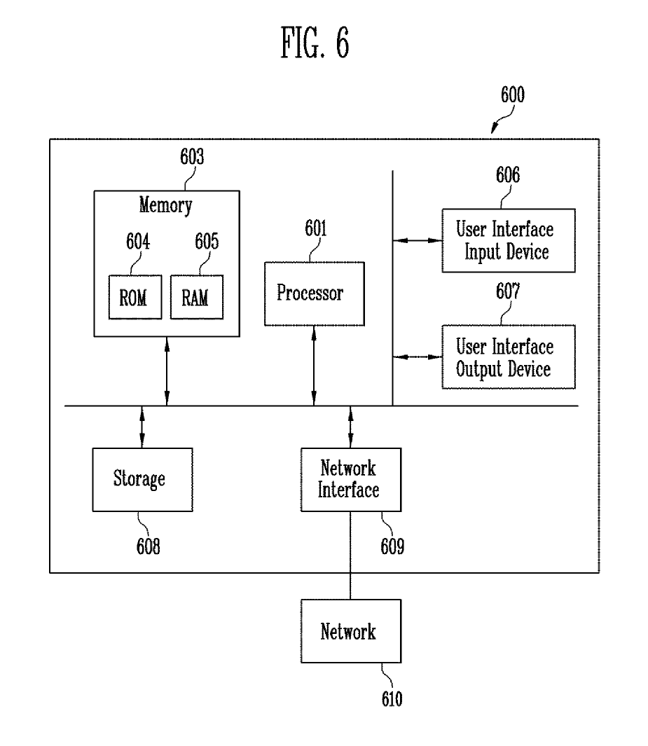

An embodiment of the present invention may be implemented in a computer system, e.g., as a computer readable medium. As shown in FIG. 6, a computer system 600 may include one or more of a processor 601, a memory 603, a user input device 606, a user output device 607, and a storage 608, each of which communicates through a bus 602. The computer system 600 may also include a network interface 609 that is coupled to a network 610. The processor 601 may be a central processing unit (CPU) or a semiconductor device that executes processing instructions stored in the memory 603 and/or the storage 608. The memory 603 and the storage 608 may include various forms of volatile or non-volatile storage media. For example, the memory may include a read-only memory (ROM) 604 and a random access memory (RAM) 605.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for generating a data distribution service application, the method comprising:
syntax-analyzing an IDL (interface description language) file;
determining a topic model to be used in the data distribution service application based on a result of the syntax-analyzing of an IDL (interface description language) file;
receiving QoS information and determining a QoS model by a QoS (quality of service) modeler;
determining a DDS application model based on the topic model and QoS model by a DDS (data distribution service) application modeler; and
generating a source code based on the topic model, QoS model and DDS application model.

2. The method according to claim 1,
wherein the topic model is a model for a topic for generating the data distribution service application, and
the topic indicates information on a format and material type of data transmitted and received in a data distribution service.

3. The method according to claim 2,
wherein the QoS model is a model for QoS for generating the data distribution service application, and
the QoS indicates an attribute of service quality that the topic or a DataWriter or DataReader of the data distribution service has.

4. The method according to claim 3,
wherein the DDS application model is modeled based on an attribute of the DataWriter or DataReader to be generated in the data distribution service application, the topic, and the QoS.

5. The method according to claim 4,
wherein the source code embodies a function for communicating with another data distribution service application based on a communication function that the data distribution service application provides in a data distribution service communication middleware.

6. An apparatus for generating a data distribution service application, the apparatus comprising:
an IDL parser configured to syntax-analyze an IDL (interface description language) file;
a topic modeler configured to determine a topic model to be used in the data distribution service application based on a result of the syntax-analyzing of an IDL file;
a QoS modeler configured to receive QoS information and to determine a QoS model;
a DDS application modeler configured to determine a DDS application model based on the topic model and QoS model; and
a source code generator configured to generate a source code based on the topic model, QoS model, and DDS application model.

7. The apparatus according to claim 6,
wherein the topic model is a model for a topic for generating the data distribution service application, and
the topic indicates information on a format and material type of data transmitted and received in a data distribution service.

8. The apparatus according to claim 7,
wherein the QoS model is a model for QoS for generating the data distribution service application, and
the QoS indicates an attribute of service quality that the topic or a DataWriter or DataReader of the data distribution service has.

9. The apparatus according to claim 8,
wherein the DDS application model is modeled based on an attribute of the DataWriter or DataReader to be generated in the data distribution service application, the topic and the QoS.

10. The apparatus according to claim 9,
wherein the source code embodies a function for communicating with another data distribution service application based on a communication function that the data distribution service application provides in a data distribution service communication middleware.
